(19) United States
(12) Patent Application Publication
(10) Pub. No.: US 2010/0326303 A1
(43) Pub. Date: Dec. 30, 2010

(54) METHOD OF CONTROLLING AN INK PROFILE IN AN INKING UNIT DURING INTERRUPTIONS OF A PRINTING OPERATION

(75) Inventors: Ulrich Luckhardt, Koln (DE); Oliver Nowarra, Leimen (DE); Willi Stutz, Neustadt (DE)

Correspondence Address: LERNER GREENBERG STEMER LLP, P O BOX 2480, HOLLYWOOD, FL, 33022-2480, US

(73) Assignee: HEIDELBERGER DRUCKMASCHINEN AKTIENGESELLSCHAFT, Heidelberg (DE)

(21) Appl. No.: 12/824,348

(22) Filed: Jun. 28, 2010

(30) Foreign Application Priority Data
Jun. 26, 2009 (DE) 10 2009 030 747.8

(51) Int. Cl. B41F 1/18

(52) U.S. Cl. 101/450.1

(57) ABSTRACT

A method of controlling an ink profile in an inking unit of a lithographic offset printing press having printing units with cylinders for transporting printing material or for applying printing ink to the printing material. One of the cylinders is a plate cylinder in the printing unit. An operating speed of the inking unit is reduced in relation to an operating speed of the cylinders for transporting printing material or for applying printing ink to the printing material when the printing press is running and the transport of printing material is switched off. The inking unit continues to operate at a reduced speed and the inking unit is disengaged from the plate cylinder during operation at a reduced speed.

### CROSS-REFERENCE TO RELATED APPLICATION

This application claims the priority, under 35 U.S.C. §119, of German Patent Application DE 10 2009 030 747.8, filed Jun. 26, 2009; the prior application is herewith incorporated by reference in its entirety.

### BACKGROUND OF THE INVENTION

Field of the Invention

The present invention relates to a method of controlling an ink profile in an inking unit of a lithographic offset printing press including printing units with cylinders for transporting printing material or for applying printing ink to the printing material.

In lithographic offset printing presses, prior to the beginning of a printing operation, a layer of ink suitable for a current print job must be provided to rollers and cylinders involved in the application of ink during printing. That ink layer is used to control print quality, since the colors on the printed product depend on a correct adjustment of the ink layer. The layer of ink applied to the rollers and cylinders in the printing unit of a lithographic offset printing press is also referred to as the ink profile. If the printing operation is interrupted during a print job, for example because of jammed sheets in a sheet-fed rotary lithographic offset printing press, the ink profile required for a continuous printing operation is flattened or at least changes. That means that once the problem that has caused the interruption is solved and the press is restarted, the ink profile required for continuous printing must be re-established. However, that process takes up valuable running time of the press and therefore ought to be avoided whenever possible.

One approach to solving that problem is known from Published German Patent Application DE 198 34 784 A1, corresponding to U.S. Pat. No. 6,758,141. That document discloses the use of an ink infeed process to establish an ink profile which closely resembles the one required for continuous printing. In order to retain that ink profile closely resembling the one required for continuous printing even during so-called paper jams, once the ink infeed process is completed, the driving of the inking unit is interrupted during the period until the end of the ink infeed process and a delayed start of the printing operation. In the ensuing time the driving of the inking unit is likewise to be interrupted in the case of paper jams. For that purpose, the inking unit may be decoupled from the plate cylinder in the printing unit of the lithographic offset printing press and from the drive gear train of the printing press through the use of a suitable switchable clutch.

A further solution to the problem is known from Published German Patent Application 10 2005 031 317 A1. That document likewise proposes to interrupt the driving of the inking unit in a printing unit of a sheet-fed lithographic offset printing press at least temporarily in the case of an interruption of the printing operation. That measure is intended to maintain the distribution of ink layer thickness in the inking unit of a printing press in the case of an interruption of the printing operation. For that purpose, the printing unit likewise includes a clutch which is operated through the use of a control unit to decouple or stop the drive of the inking unit. Instead of the clutch, a separate drive controlled by the control unit of the printing press may be provided for the inking unit.

However, stopping the inking unit incurs certain disadvantages. For example, after a restart of the inking unit after a standstill, stripes are formed on the first printed sheets, thus resulting in waste sheets.

### SUMMARY OF THE INVENTION

It is accordingly an object of the present invention to provide a method of controlling a lithographic offset printing press, which overcomes the hereinafore-mentioned disadvantages of the heretofore-known methods of this general type in such a way that it assists in maintaining an ink profile for continuous printing and avoids a formation of stripes when an inking unit is switched off in the case of interruptions of a printing operation.

With the foregoing and other objects in view there is provided, in accordance with the invention, a method of controlling an ink profile in an inking unit of a lithographic offset printing press. The method comprises providing a printing unit with the inking unit and with cylinders for transporting printing material or for applying printing ink to the printing material, one of the cylinders being a plate cylinder, reducing an operating speed of the inking unit in relation to an operating speed of the cylinders for transporting printing material or for applying printing ink to the printing material when the printing press is running and transport of the printing material is switched off, continuing to operate the inking unit at a reduced speed, and disengaging the inking unit from the plate cylinder during operation at a reduced speed.

The present invention may be applied to sheet-fed rotary lithographic offset printing presses and to web-fed rotary lithographic offset printing presses. The method of the invention may be controlled by the drive control unit of such a lithographic offset printing press. Lithographic offset printing presses generally include a number of printing units, which may be of substantially identical construction. Each of the printing units is formed of an inking unit and a dampening unit. The inking unit and the dampening unit together provide the ink emulsion necessary for the printing operation. In the printing unit, this ink emulsion is transferred onto the printing plate on the plate cylinder. From the printing plate, the ink emulsion is transferred to a downstream blanket cylinder, which then transfers the ink emulsion to the printing material in a printing nip formed between the blanket cylinder and an impression cylinder. Transport cylinders are provided between the impression cylinders of the individual printing units to transport the printing material between the printing units in sheet-fed lithographic offset printing presses. In order to avoid changes to the ink profile required for continuous printing in the printing unit of the prior art devices, the inking unit is switched off in the case of an interruption of the printing operation. In accordance with the present invention, however, such a standstill does not occur. Instead, with the printing press running and transport of printing materials switched off, the operating speed of the inking unit is reduced in relation to the operating speed of the cylinders for transporting printing material or of the cylinders for applying printing ink to the printing material, and the inking unit continues to be operated at a reduced speed. An important advantage of this reduced operating speed is that changes to the ink profile in the printing unit are minimized. Such minimal changes do not have any negative effect on the continued printing operation. In addition, since the inking unit is not brought to a standstill, the formation of stripes as occur in the prior art is avoided. As a consequence, the printing press can be restarted much more quickly after an interruption of the printing operation. Thus, periods of standstill and the production of waste paper are reduced. The method of the invention may be applied whenever the transport of printing material is stopped but most other aggregates of the press continue to operate. This applies in particular when the interruption of the printing operation is caused by a sheet jam.

In accordance with one embodiment of the invention, the inking unit is operated during the printing operation in synchronism with the cylinders for transporting printing material or for applying printing ink to the printing material in the lithographic offset printing press. Whereas the operating speed of the inking unit is reduced in relation to the operating speed of the cylinders when interruptions of the printing operation and a stopping of the transport of printing material occur, the inking unit is operated in synchronism with the cylinders during continuous printing. This ensures satisfactory print quality during continuous printing with printing material transport switched on.

In accordance with a further embodiment of the invention, the cylinders for transporting printing material or for applying printing ink to the printing material are driven by one or more main drive motors of the printing press. In sheet-fed rotary lithographic offset printing presses as well as in web-fed rotary lithographic offset printing presses, the transport cylinders and the plate cylinders and blanket cylinders may be mechanically coupled to each other or the cylinders may be provided with individual drive motors as is the case in particular in web-fed lithographic offset printing presses. Moreover, it is likewise possible to provide a respective main drive motor for individual printing units or printing unit groups. In sheet-fed lithographic offset printing presses, all cylinders are generally coupled by a mechanical gear train, which means that all printing units of the press are driven by a main drive motor. In the present description of the invention, “main drive motor” refers to a motor which drives plate cylinders, blanket cylinders, impression cylinders, or transport cylinders in the printing units of the printing press.

In accordance with an added embodiment of the invention, the inking unit may be continually driven by its own auxiliary drive motor. Of course, in addition to the inking unit, this auxiliary drive motor may also drive the dampening unit, for example. However, the auxiliary drive motor does not drive the plate cylinder, blanket cylinder, or impression cylinder in the printing unit. These cylinders are driven by the main drive motors or main drive motor. An important advantage of providing the auxiliary drive motor for the inking unit is that the speed of the inking unit can be controlled in a manner completely independent of the speed of the main drive motor. Through the use of an electronically controlled electric motor as is common today, it is thus possible to provide infinitely variable control of the rotary speed of the auxiliary drive motor and thus of the inking unit.

In accordance with an additional embodiment of the invention, in the reduced-speed mode, the inking unit is advantageously driven by an auxiliary drive motor, whereas in the printing mode, it is driven by the at least one main drive motor of the cylinders for transporting printing material or for applying printing ink to the printing material. In accordance with this embodiment of the invention, the inking unit and, if present, the associated dampening unit, are equipped with an auxiliary drive motor, which allows infinitely variable control of the speed of the inking unit. In the printing mode, however, the inking unit is coupled to the cylinders in the printing unit through a clutch. Thus, it may be driven by the main drive motor(s) in the printing press. In this manner, in the printing mode, the speed of the inking unit is mechanically synchronized with the cylinders for printing and for transporting printing material. For this purpose, it is therefore necessary to provide a mechanical or electromagnetic clutch for coupling the inking unit to the other cylinders. In this manner, in the reduced-speed mode, the inking unit may in turn be decoupled from the at least one main drive motor and coupled to the auxiliary drive motor through the use of the clutch. In accordance with this embodiment, the inking unit is thus always driven by only one motor, i.e. either by the auxiliary drive motor or by the main drive motor. However, it is likewise possible for the auxiliary drive motor to be always running so that in the printing mode, the inking unit is driven by the auxiliary drive motor as well as by the main drive motor(s) through the cylinders in the printing unit to which it is mechanically coupled. In this case, it is possible to make use of the driving force of the auxiliary drive motor in addition to driving the cylinders in the printing press in the printing mode.

In accordance with yet a further embodiment of the invention, in order to operate the inking unit at a reduced speed, the transmission ratio between the main drive motor and the inking unit is varied through the use of a gearing mechanism. In accordance with this embodiment, no auxiliary motor is provided in the printing unit to drive the inking unit at a reduced speed. In this case, the inking unit is driven by the main drive motor of the printing press even when the inking unit is in the reduced-speed mode. Instead, a variable transmission ratio gearing mechanism is provided in the drive train between the main drive motor and the inking unit. Thus, the speed of the inking unit in relation to the rest of the drive train, for example the plate cylinder in the printing unit, can be reduced through the use of the gearing mechanism. In accordance with this embodiment, in the printing mode, the inking unit is coupled to a cylinder in the printing unit. Furthermore, in accordance with this embodiment, a clutch may be provided to couple the inking unit to a gearing operating at a first transmission ratio in the printing mode and to a gearing operating at a second transmission ratio for operating the inking unit in the reduced- speed mode. In accordance with this embodiment, a first gearing mechanism having a fixed transmission ratio is provided for the printing mode and a second gearing mechanism having a second transmission ratio is provided for the reduced-speed mode. A clutch is used to switch between the modes of operation, i.e. between the two gearing mechanisms.

In accordance with an advantageous embodiment, the printing unit may include a dampening unit, which is mechanically coupled to the inking unit. In accordance with this mode of operation, the dampening unit does not need its own drive motor. Instead, it is driven by the drive of the inking unit. This applies when the inking unit has its own drive motor as well as to a purely mechanical embodiment in which the inking unit is coupled to the main drive by a gearing mechanism.

In accordance with an added embodiment of the invention, one of the cylinders is the plate cylinder in the printing unit, and in the reduced-speed mode, the inking unit is thrown off or disengaged from the plate cylinder. This embodiment ensures that the inking unit does not transfer any ink to the plate cylinder when paper transport is switched off and consequently that the amount of ink on the plate cylinder does no longer change. In accordance with a further feature of the invention, rollers in the inking unit may be thrown off or disengaged from each other when the inking unit is operated in the reduced-speed mode. Disengaging individual rollers or roller trains in the inking unit ensures that the distribution of ink on the rollers does not vary while the transport of printing material is switched off.

In accordance with a concomitant feature of the invention, the inking unit may be operated in the reduced-speed mode in the period following ink infeed and preceding the start of the printing operation. During this period, the transport of printing material is switched off prior to the start of the printing operation, and the ink profile in the inking unit is adjusted once the ink infeed has been completed.

Other features which are considered as characteristic for the invention are set forth in the appended claims.

Although the invention is illustrated and described herein as embodied in a method of controlling an ink profile in an inking unit during interruptions of a printing operation, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, longitudinal-sectional view of an inking unit including its own drive motor;

FIG. 2 is a longitudinal-sectional view of an inking unit including its own drive motor and a clutch to couple the inking unit to a main drive; and

FIG. 3 is a longitudinal-sectional view of an inking unit including a clutch to couple the inking unit to the main drive motor.

### DETAILED DESCRIPTION OF THE INVENTION

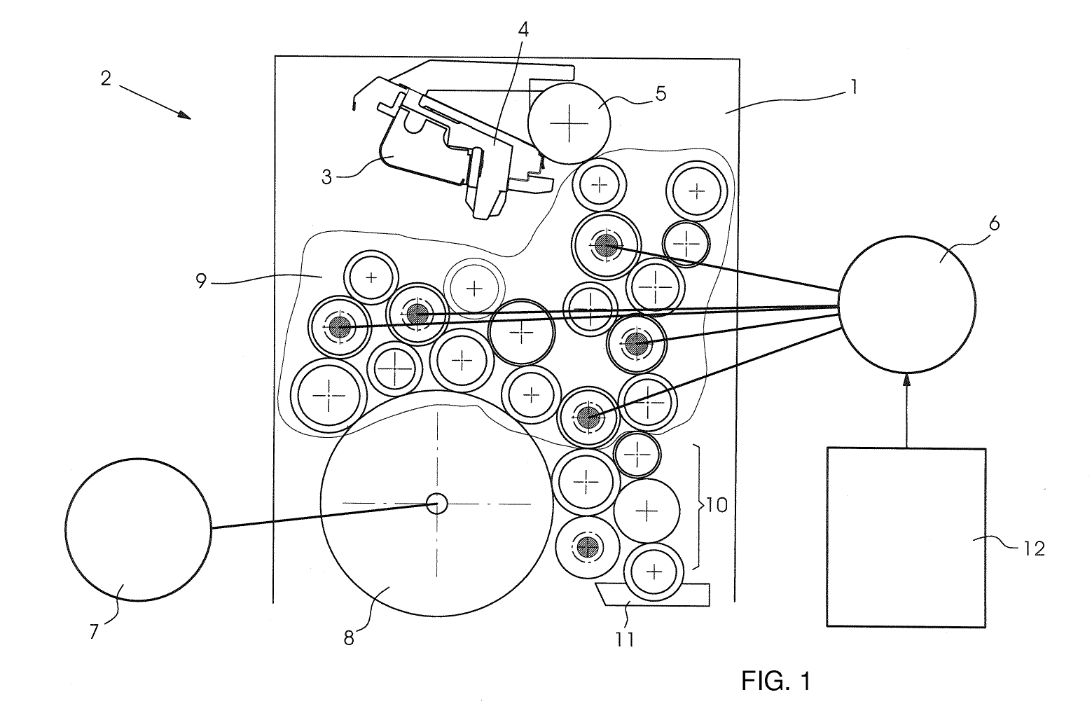

Referring now to the figures of the drawings in detail and first, particularly, to FIG. 1 thereof, there is seen a diagrammatic illustration of a printing press 2. Only one printing unit 1 of the printing press 2 is shown as an example. This printing unit 1 is formed of an inking unit 9, an ink fountain 3 including a metering element 4 and a downstream ink fountain roller 5, and a dampening unit 10 including a plate cylinder 8. Further printing unit components, such as a blanket cylinder, an impression cylinder or transport cylinders, are not shown. In the printing unit 1 shown in FIG. 1, rollers of the inking unit 9 are driven by a separate inking unit drive 6 both in a printing mode and in set-up and reduced-speed modes. This inking unit drive 6 is constructed as an auxiliary electric drive motor and is controlled by a control unit 12 of the printing press 2. This control unit 12 also controls a main drive motor 7 and opening of the metering element 4. The control unit 12 is likewise used to set up and make adjustments to the printing press 2.

In sheet-fed rotary lithographic offset printing presses 2, the main drive motor 7 usually drives transport cylinders, impression cylinders, blanket cylinders and plate cylinders 8 in the printing mode and indirectly through a gear train in the set-up mode. In most sheet-fed lithographic offset printing presses 2, all of the printing units 1 are connected by a common gear train and are driven by one or more main drive motors 7. It is likewise possible to provide an individual main drive motor 7 at least for each printing unit 1. Such a motor 7 would then drive the plate cylinder 8, the blanket cylinder and the impression cylinders in the respective printing unit 1. The inking unit drive 6 is mechanically decoupled from the plate cylinder 8 and the main drive motor 7. Thus, in the printing mode and in the reduced-speed mode, the operation of the inking unit 9 and the operation of the plate cylinder 8 are electrically synchronized, but not mechanically coupled. The ink fountain roller 5 and the dampening unit 10 may be mechanically coupled to the rollers of the inking unit 9 and are thus also driven by the inking unit drive 6.

The rollers of the inking unit 9 are used to even out the predetermined amount of ink supplied by the ink fountain roller 5 from the ink fountain 3 as metered by the metering element 4. Moreover, the ink in the inking unit 9 is mixed with a dampening solution provided by a dampening solution container 11 and transferred to the rollers of the inking unit 9 by the dampening unit 10. When the rollers of the inking unit 9 are engaged with each other and with the plate cylinder 8, this ink/dampening solution emulsion is applied to a printing plate on the plate cylinder 8, transferred to a non-illustrated blanket cylinder and finally to the printing material.

When the printing operation is interrupted, printing material transport is switched off. This means that a sheet feeder is switched off and no printing material is supplied to the printing units 1. In this state, the cylinders such as the plate cylinders 8 of the printing units 1 continue to rotate. Thus, the ink profile in the inking unit 9 would change. For this reason, the rollers of the inking unit 9 are preferably disengaged from the plate cylinder 8 and the speed of the inking unit 9 is reduced to a considerable extent so that the rollers in the inking unit 9 only rotate slowly. This slow rotary movement is caused by the inking unit drive 6, which means that the speed of the plate cylinder 8 does not have to be changed. The varying speeds of the rollers in the inking unit 9 and of the plate cylinder 8 are set by the control unit 12 of the printing press 1, which controls and actuates the main drive 7 and the inking unit drive 6.

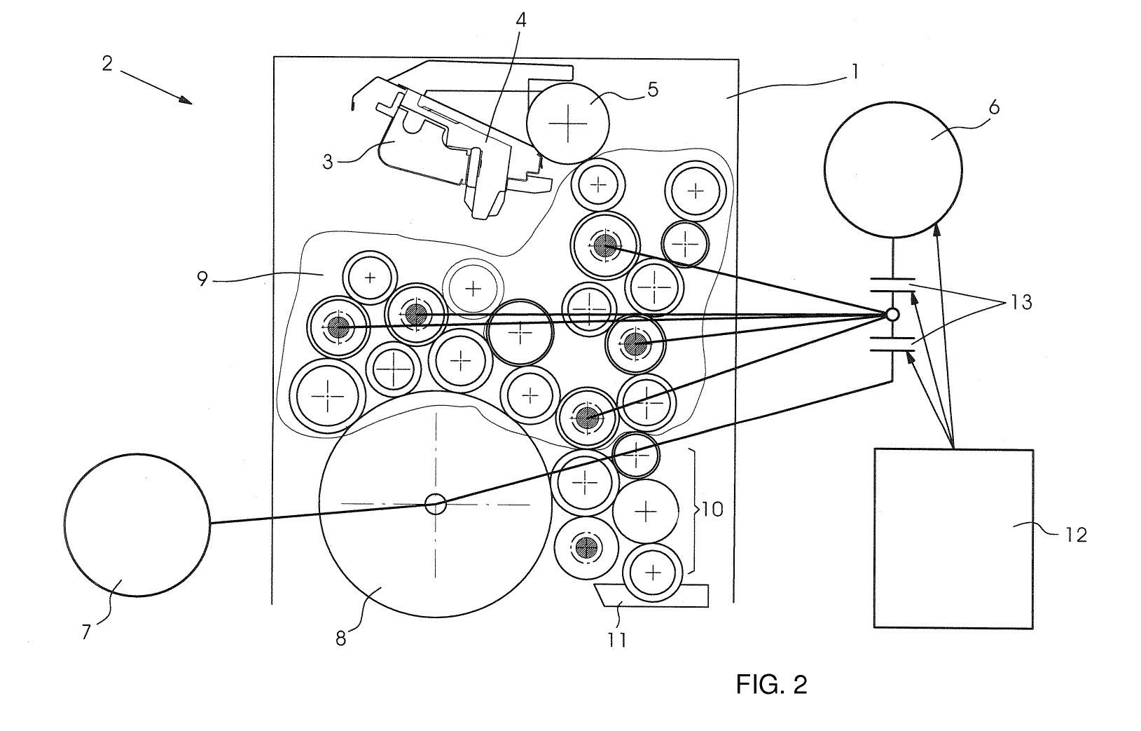

In addition to the exclusively electrical embodiment illustrated in FIG. 1, a combined electrical/mechanical embodiment as shown in FIG. 2 is conceivable. In this case, too, an electric motor is provided as an inking unit drive 6, which drives the rollers of the inking unit 9. However, the inking unit motor 6, the rollers of the inking unit 9, and the plate cylinder 8 are couplable in a mechanical way through the use of clutches 13. An advantage of this feature is that in the printing mode, a fixed mechanical synchronization may be established between the inking unit rollers 9 and the plate cylinder 8 when an upper clutch 13 is open and a lower clutch 13 is closed. This means that in the printing mode, both the rollers of the inking unit 9 and the plate cylinder 8 are driven by the main drive motor 7. In the reduced-speed mode, however, the lower clutch 13 is opened and the upper clutch 13 is closed, so that the inking unit rollers in the inking unit 9 are then decoupled from the plate cylinder 8 and are exclusively driven electrically by the inking unit drive 6. Thus, in the decoupled state, the speed of the rollers of the inking unit 9 is infinitely variable by the inking unit drive 6. The clutches 13 are actuated by the control unit 12.

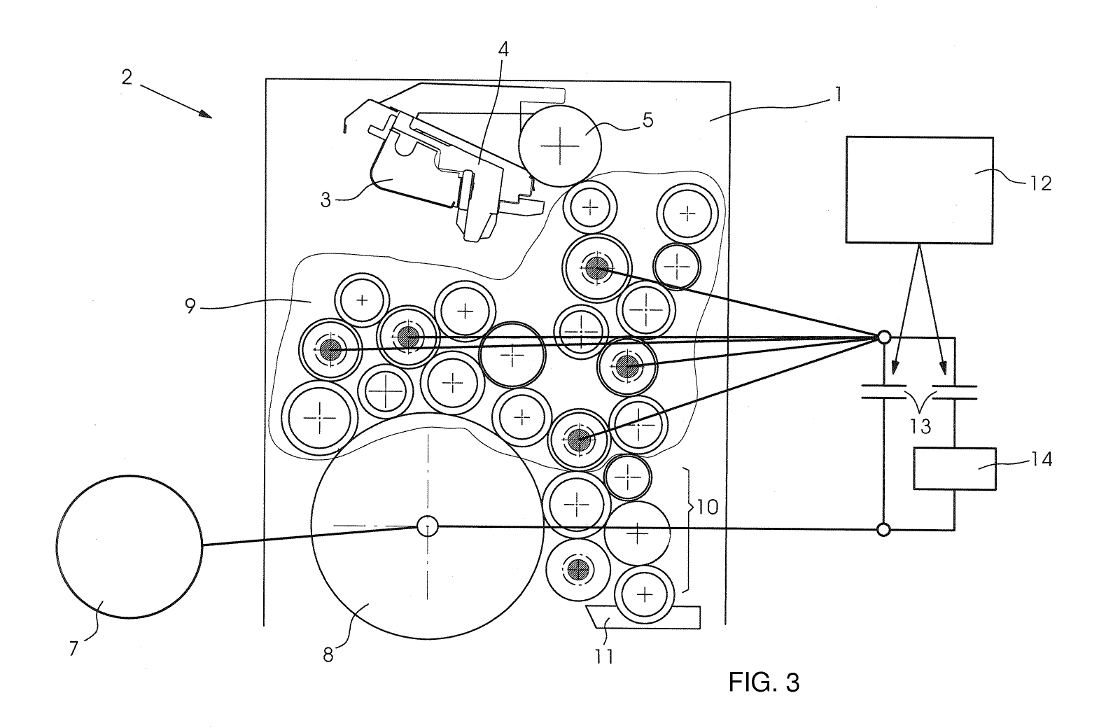

FIG. 3 illustrates a purely mechanical embodiment which does not include an electric motor as an inking unit drive 6. Two clutches 13 are provided to couple the rollers of the inking unit 9 through different transmission ratios to the plate cylinder 8, which in turn is connected to the main drive 7. In the embodiment shown in FIG. 3, the left-hand clutch 13 is closed and the right-hand clutch 13 is open in the printing mode so that the rollers of the inking unit 9 and the plate cylinder 8 are mechanically coupled to and synchronized with each other to be driven at the same speed by the main drive 7. When an interruption of the printing operation occurs, the left-hand clutch 13 is opened and the right-hand clutch 13 is closed. As a result, a reduction gearing mechanism is connected between the plate cylinder 8 and the rollers of the inking unit 9. This reduction gearing 14 causes the rollers of the inking unit 9 to rotate at a much lower speed. Thus, the desired reduced-speed mode of the inking unit 9 is attained. In this case, too, the clutches 1 are controlled and actuated by the control unit 12 to switch from one mode of operation to another.

A common feature of all three embodiments is that the speed of the inking unit rollers in relation to the speed of the remaining cylinders 8 in the printing unit 1 may be reduced to a considerable extent to be able to drive the rollers of the inking unit 9 at a reduced operating speed, thus avoiding a flattening of the ink profile on one hand and a formation of stripes due to a standstill of the rollers of the inking unit 9 on the other hand.

1. A method of controlling an ink profile in an inking unit of a lithographic offset printing press, the method comprising the following steps:
providing a printing unit with the inking unit and with cylinders for transporting printing material or for applying printing ink to the printing material, one of the cylinders being a plate cylinder;
reducing an operating speed of the inking unit in relation to an operating speed of the cylinders for transporting printing material or for applying printing ink to the printing material when the printing press is running and transport of the printing material is switched off;
continuing to operate the inking unit at a reduced speed; and
disengaging the inking unit from the plate cylinder during operation at a reduced speed.

2. The method according to claim 1, which further comprises operating the inking unit in synchronism with the cylinders for transporting printing material or for applying printing ink to the printing material during printing in the lithographic offset printing press.

3. The method according to claim 1, which further comprises continuously driving the inking unit with its own auxiliary drive motor.

4. The method according to claim 1, which further comprises:
driving the inking unit with at least one auxiliary drive motor in a reduced-speed mode; and
driving the inking unit with at least one main drive motor of the cylinders for transporting printing material or for applying printing ink to the printing material in a printing mode.

5. The method according to claim 4, which further comprises decoupling the inking unit from the at least one main drive motor and coupling the inking unit to the at least one auxiliary drive motor with a clutch in the reduced-speed mode.

6. The method according to claim 1, which further comprises modifying a transmission ratio between a main drive motor and the inking unit with a gearing mechanism in a reduced-speed mode of the inking unit.

7. The method according to claim 1, which further comprises:
decoupling the inking unit from a first transmission ratio in a printing mode, and
coupling the inking unit to a gearing mechanism having a second transmission ratio for operation in a reduced-speed mode, with a clutch.

8. The method according to claim 1, which further comprises switching the inking unit between a printing mode and a reduced-speed mode with an electronic control unit.

9. The method according to claim 1, which further comprises disengaging rollers in the inking unit from each other during reduced-speed operation of the inking unit.

10. The method according to claim 1, which further comprises operating the inking unit in a reduced-speed mode during a period following an infeed of the printing ink and preceding a start of printing operation.
